(19) United States
(12) Patent Application Publication
(10) Pub. No.: US 2007/0285384 A1
(43) Pub. Date: Dec. 13, 2007

(54) Liquid crystal display with interface circuit

(75) Inventor: Yi-Yin Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/811,509

(22) Filed: Jun. 11, 2007

(30) Foreign Application Priority Data
Jun. 9, 2006 (TW) 95120555

(51) Int. Cl. G09G 3/36

(52) U.S. Cl. 345/104

(57) ABSTRACT

An exemplary liquid crystal display (LCD) (200) includes an LCD panel (210) and a driving circuit (220). The driving circuit includes a signal generator (221), an LCD panel driver (223), and an interface circuit (225). The signal generator generates data signals, system controlling signals, image controlling signals, and an interface select signal. The interface circuit includes system controlling lines for transmitting the system controlling signals to the LCD panel driver, image controlling lines for transmitting the image controlling signals to the LCD panel driver, data lines for transmitting the data signals to the LCD panel driver, and an interface select line for transmitting the interface select signal to the LCD panel driver. The LCD panel driver electrically connects to either the image controlling lines or the system controlling lines, the connection being according to the a type of the interface select signal transmitted through the interface select line.

### FIELD OF THE INVENTION

The present invention relates to liquid crystal displays (LCDs) and, particularly, to an LCD having an interface circuit for transmitting data signals and image signals.

### GENERAL BACKGROUND

An LCD has the advantages of portability, low power consumption, and low radiation. LCDs have been widely used in various portable information products such as notebooks, personal digital assistants (PDAs), video cameras and the like. Furthermore, the LCD is considered by many to have the potential to completely replace CRT (cathode ray tube) monitors and televisions.

FIG. 3 is a block diagram including circuitry of a typical LCD. The LCD 100 includes an LCD panel 110 and a driving circuit 120. The driving circuit 120 includes a signal generator 121, an interface circuit 122, and an LCD panel driver 123. The signal generator 121 includes a system controlling unit 1213 and an image controlling unit 1215. The interface circuit 122 includes a plurality of system controlling lines 1221 and a plurality of image controlling lines 1222.

The system controlling unit 1213 is configured to generate a plurality of system controlling signals and data signals. The system controlling signals include a read (RD) signal, a write (WR) signal, a register select (RS) signal, and a chip select (CS) signal. The system controlling lines 1221 includes an RD line for transmitting the RD signal, a WR line for transmitting the WR signal, an RS line for transmitting the RS signal, a CS line for transmitting the CS signal, and data lines D0-D17 for transmitting the data signals.

The image controlling unit 1215 is configured to generate image controlling signals and image signals. The image controlling signals includes a vertical synchronization (VSYNC) signal, a horizontal synchronization (HSYNC) signal, a dot clock (DOTCLK) signal, and a data enable (ENABLE) signal. The image controlling lines 1222 includes a VSYNC line for transmitting the VSYNC signal, an HSYNC line for transmitting the HSYNC signal, a DOTCLK line for transmitting the DOTCLK signal, an ENABLE line for transmitting the data enable signal, and data lines PD0-PD17 for transmitting the image signals.

Because the interface circuit 122 includes the data lines D0-D17 and the data lines PD0-PD17, which are for respectively transmitting the data signals and image signals, a layout of the interface circuit 122 is quite complicated. Accordingly, a layout of the LCD 100 is quite complicated.

It is desired to provide an LCD which can overcome the above-described deficiencies.

### SUMMARY

In one preferred embodiment, an LCD includes an LCD panel and a driving circuit configured for driving the LCD panel. The driving circuit includes a signal generator, an LCD panel driver, and an interface circuit. The signal generator is configured for generating a plurality of data signals, a plurality of system controlling signals, a plurality of image controlling signals, and an interface select signal. The LCD panel driver is configured for driving the LCD panel to display images on the LCD panel. The interface circuit includes a plurality of system controlling lines configured for transmitting the system controlling signals to the LCD panel driver, a plurality of image controlling lines configured for transmitting the image controlling signals to the LCD panel driver, a plurality of electrical data lines for transmitting the data signals to the LCD panel driver, and an interface select line configured for transmitting the interface select signal to the LCD panel driver. The LCD panel driver electrically connects to either the image controlling lines for transmitting of the image controlling signals to the LCD panel driver or the system controlling lines for transmitting of the system controlling signals to the LCD panel driver, the connection being according to the a type of the interface select signal transmitted through the interface select line.

Other novel features and advantages will become more apparent from the following detailed description when taken in conjunction with the accompanying drawings.

### BRIEF DESCRIPTION OF THE DRAWINGS

FIG. 1 is a block diagram including circuitry of an LCD according to a first embodiment of the present invention.

FIG. 2 is a block diagram including circuitry of an LCD according to a second embodiment of the present invention.

FIG. 3 is a block diagram including circuitry of a conventional LCD.

### DETAILED DESCRIPTION OF PREFERRED EMBODIMENTS

Reference will now be made to the drawings to describe various embodiments of the present invention in detail.

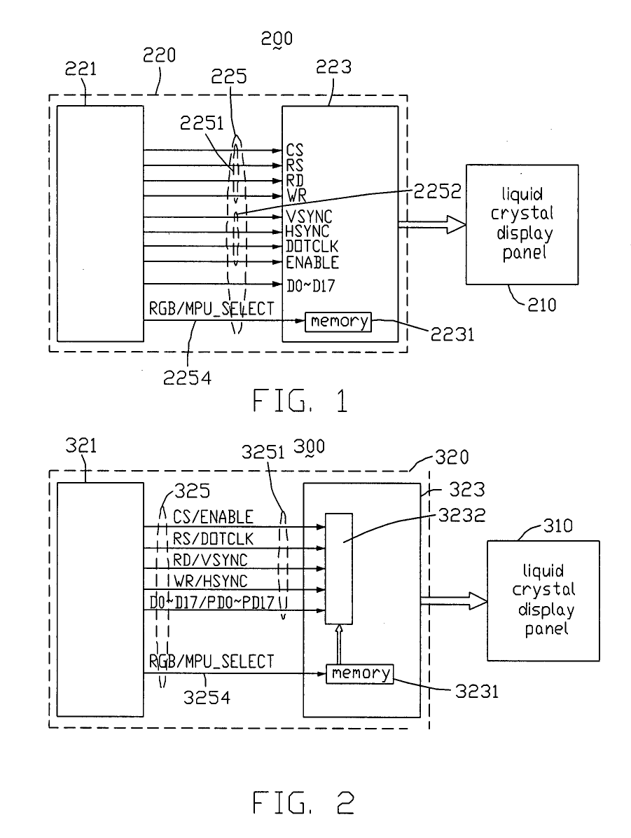

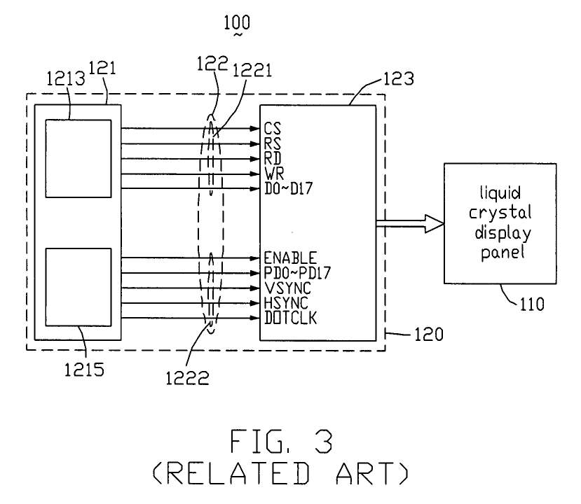

FIG. 1 is a block diagram including circuitry of an LCD according to a first embodiment of the present invention. The LCD 200 includes an LCD panel 210 and a driving circuit 220. The driving circuit 220 includes a signal generator 221, an interface circuit 225, and an LCD panel driver 223.

The signal generator 221 is configured to generate a plurality of data signals, a plurality of system controlling signals, a plurality of image controlling signals, and an interface select signal “RGB/MPU_select”. The system controlling signals include an RD signal, a WR signal, an RS signal, and a CS signal. The image controlling signals includes a VSYNC signal, an HSYNC signal, a DOTCLK signal, and an ENABLE signal. The interface select signal “RGB/MPU_select” can be a high level voltage signal or a low level voltage signal.

The interface circuit 225 includes a plurality of system controlling lines 2251, a plurality of image controlling lines 2252, a plurality of data lines D0-D17, and an interface select line 2254. The system controlling lines 2251 are configured to transmit the system controlling signals from the signal generator 221 to the LCD panel driver 223. The image controlling lines 2252 are configured to transmit the image controlling signals from the signal generator 221 to the LCD panel driver 223. The data lines D0-D17 are electrically connected to a data bus line (not shown) of the LCD panel driver 223.

The LCD panel driver 223 includes a memory 2231 connected to the interface select line 2254. The memory 2231 is configured to store two interface-select parameters. The interface-select parameters can be chosen according to the particular interface select signal “RGB/MPU_select” transmitted through the interface select line 2254.

If the interface select signal “RGB/MPU_select” is a high level voltage signal, one of the interface-select parameters is chosen by the LCD panel driver 223. Accordingly, the LCD panel driver 223 electrically connects with the system controlling lines 2251 and the data lines D0-D17, and electrically disconnects from the image controlling lines 2252. Then, the system controlling signals and the data signals generated by the signal generator 221 are transmitted respectively through the system controlling lines 2251 and the data lines D0-D17 to the LCD panel driver 223. Therefore the LCD panel driver 223 drives the LCD panel 210 according to the received system controlling signals and data signals, in order to display system controlling information on the LCD panel 210.

If the interface select signal “RGB/MPU_select” is a low level voltage signal, the other one of the interface-select parameters is chosen by the LCD panel driver 223. Accordingly, the LCD panel driver 223 electrically connects with the image controlling lines 2252 and the data lines D0-D17, and electrically disconnects from the system controlling lines 2251. Then, the image controlling signals and the data signals generated by the signal generator 221 are transmitted respectively through the image controlling lines 2252 and the data lines D0-D17 to the LCD panel driver 223. Therefore the LCD panel driver 223 drives the LCD panel 210 according to the received image controlling signals and data signals, in order to display pictures on the LCD panel 210.

Because the interface circuit 225 includes the interface select line 2254, the LCD panel driver 223 can choose one of the parameters according to the corresponding interface select signal “RGB/MPU_select” transmitted through the interface select line 2254. Then the LCD panel driver 223 connects with the image controlling lines 2252 and disconnects from the system controlling lines 2251, or connects with the system controlling lines 2251 and disconnects from the image controlling lines 2252, depending on the particular parameter chosen. Thus the data lines D0-D17 of the interface circuit 225 connected between the signal generator 221 and the LCD panel driver 223 can be shared by the system controlling signals and the image controlling signals. As a result, a layout of the interface circuit 225 is simple and, therefore, a layout of the LCD 200 is correspondingly simple.

FIG. 2 is a block diagram including circuitry of an LCD according to a second embodiment of the present invention. The LCD 300 includes an LCD panel 310, and a driving circuit 320 configured to drive the LCD panel 310. The driving circuit 320 includes a signal generator 321, an interface circuit 325, and an LCD panel driver 323.

The signal generator 321 is configured to generate a plurality of data signals and image signals, a plurality of system controlling signals, a plurality of image controlling signals, and an interface select signal “RGB/MPU_select”. The system controlling signals includes an RD signal, a WR signal, an RS signal, and a CS signal. The image controlling signals includes a VSYNC signal, an HSYNC signal, a DOTCLK signal, and an ENABLE signal. The interface select signal “RGB/MPU_select” can be a high level voltage signal or a low level voltage signal.

The interface circuit 325 includes a plurality of system/image controlling lines 3251 and an interface select line 3254. The system/image controlling lines 3251 includes a first conducting line (not labeled) configured to transmit the WR signal or the HSYNC signal from the signal generator 321 to the LCD panel driver 323, a second conducting line (not labeled) configured to transmit the RD signal or the VSYNC signal from the signal generator 321 to the LCD panel driver 323, a third conducting line (not labeled) configured to transmit the RS signal or the DOTCLK signal from the signal generator 321 to the LCD panel driver 323, a fourth conducting line (not labeled) configured to transmit the CS signal or the ENABLE signal from the signal generator 321 to the LCD panel driver 323, and a plurality of data lines D0-D17/PD0-PD17 configured to transmit the data signals or image signals from the signal generator 221 to the LCD panel driver 323. The interface select line 3254 is configured to transmit the interface select signal “RGB/MPU_select”.

The LCD panel driver 323 includes a memory 3231 connected to the interface select line 3254, and a multiplexer 3232 connected to the system/image controlling lines 3251. The memory 3231 is configured to store two interface-select parameters. The interface-select parameters can be chosen according to the particular interface select signal “RGB/MPU_select” transmitted through the interface select line 3254. Thereupon, the interface-select parameter actually chosen is transmitted to the multiplexer 3232.

If the interface select signal “RGB/MPU_select” is a high level voltage signal, one of the interface-select parameters is chosen by the LCD panel driver 323. Accordingly, the multiplexer 3232 electrically connects with a first internal circuit (not shown) of the LCD panel driver 323. Then, the system controlling signals and the data signals generated by the signal generator 321 are transmitted through the system/image controlling lines 3251 and the multiplexer 3232 to the first internal circuit of the LCD panel driver 323. Therefore the LCD panel driver 323 drives the LCD panel 310 according to the system controlling signals and data signals, in order to display system controlling information on the LCD panel 310.

If the interface select signal “RGB/MPU_select” is a low level voltage signal, the other one of the interface-select parameters is chosen by the LCD panel driver 323. Accordingly, the multiplexer 3232 electrically connects with a second internal circuit (not shown) of the LCD panel driver 323. Then, the image controlling signals and the image signals generated by the signal generator 321 are transmitted through the system/image controlling lines 3251 and the multiplexer 3232 to the second internal circuit of the LCD panel driver 323. Therefore the LCD panel driver 323 drives the LCD panel 310 according to the received image controlling signals and data signals, in order to display pictures on the LCD panel 310.

Because the interface circuit 325 includes the interface select line 3254, the LCD panel driver 323 can choose one of the parameters according to the corresponding interface select signal “RGB/MPU_select” transmitted through the interface select line 2254. Then the multiplexer 3232 connects with the first internal circuit or the second internal circuit of the LCD panel driver 323, depending on the particular parameter chosen. Thus, the system/image controlling lines 3251 of the interface circuit 325 connected between the signal generator 321 and the LCD panel 310 can be shared by the system controlling signals and the image controlling signals. As a result, a layout of the interface circuit 325 is simple, and therefore a layout of the LCD 300 is correspondingly simple.

It is to be understood, however, that even though numerous characteristics and advantages of preferred and exemplary embodiments have been set out in the foregoing description, together with details of the structures and functions of the embodiments, the disclosure is illustrative only; and that changes may be made in detail, especially in matters of arrangement of parts within the principles of present invention to the full extent indicated by the broad general meaning of the terms in which the appended claims are expressed.

What is claimed is:

1. A liquid crystal display (LCD) comprising:
an LCD panel; and
a driving circuit configured for driving the LCD panel, the driving circuit comprising:
a signal generator configured for generating a plurality of data signals, a plurality of system controlling signals, a plurality of image controlling signals, and an interface select signal;
an LCD panel driver configured for driving the LCD panel to display images on the LCD panel; and
an interface circuit comprising:
a plurality of system controlling lines configured for transmitting the system controlling signals to the LCD panel driver;
a plurality of image controlling lines configured for transmitting the image controlling signals to the LCD panel driver;
a plurality of data lines configured for transmitting the data signals to the LCD panel driver; and
an interface select line configured for transmitting the interface select signal to the LCD panel driver;
wherein the LCD panel driver electrically connects with either the image controlling lines for transmitting of the image controlling signals to the LCD panel driver or the system controlling lines for transmitting of the system controlling signals to the LCD panel driver, the connection being according to the a type of the interface select signal transmitted through the interface select line.

2. The LCD as claimed in claim 1, wherein the LCD panel driver comprises a memory, the memory is configured for storing two interface-select parameters and for connecting to the interface select line, and the interface-select parameters are selectable according to the type of interface select signal transmitted through the interface select line.

3. The LCD as claimed in claim 2, wherein the types of interface select signal comprise a high level voltage signal and a low level voltage signal, which respectively correspond to the two interface-select parameters.

4. The LCD as claimed in claim 3, wherein when the interface select signal is a high level voltage signal, the LCD panel driver electrically connects with the system controlling lines for transmitting the system controlling signals from the signal generator to the LCD panel driver and electrically disconnects from the image controlling lines.

5. The LCD as claimed in claim 3, wherein when the interface select signal is a low level voltage signal, the LCD panel driver electrically connects with the image controlling lines for transmitting the image controlling signals from the signal generator to the LCD panel driver and electrically disconnects from the system controlling lines.

6. The LCD as claimed in claim 1, wherein the LCD panel driver comprises a data bus line electrically connected to the data lines of the interface circuit.

7. The LCD as claimed in claim 1, wherein the system controlling signals comprise a read signal, a write signal, a register select signal, and a chip select signal.

8. The LCD as claimed in claim 1, wherein the image controlling signals comprise a vertical synchronization signal, a horizontal synchronization signal, a dot clock signal, and a data enable signal.

9. A liquid crystal display (LCD) comprising:
an LCD panel; and
a driving circuit configured for driving the LCD panel, the driving circuit comprising:
a signal generator configured for generating a plurality of data signals and a plurality of image signals, a plurality of system controlling signals, a plurality of image controlling signals, and an interface select signal;
an LCD panel driver configured for driving the LCD panel to display images on the LCD panel; and
an interface circuit comprising:
a plurality of system/image controlling lines configured for transmitting the system controlling signals or image controlling signals to the LCD panel; and
an interface select line configured for transmitting the interface select signal to the LCD panel driver;
wherein the LCD panel driver receives either the image controlling signals or the system controlling signals from the signal generator, according to a type of the interface select signal transmitted through the interface select line.

10. The LCD as claimed in claim 9, wherein the LCD panel driver comprises a memory, the memory is configured for storing two interface-select parameters and for connecting to the interface select line, and the interface-select parameters are selectable according to the type of interface select signal transmitted through the interface select line.

11. The LCD as claimed in claim 10, wherein the types of interface select signal comprise a high level voltage signal and a low level voltage signal, which respectively correspond to the two interface-select parameters.

12. The LCD as claimed in claim 11, wherein the LCD driver further comprises a multiplexer connected to the memory and configured for receiving one of the two interface-select parameters according to the type of interface select signal transmitted through the interface select line.

13. The LCD as claimed in claim 12, wherein when the multiplexer receives a first one of the interface-select parameters, the system controlling signals and the data signals are transmitted through the system/image controlling lines and the multiplexer to a first internal circuit of the LCD panel driver.

14. The LCD as claimed in claim 12, wherein when the multiplexer receives a second one of the interface-select parameters, the image controlling signals and the image signals are transmitted through the system/image controlling lines and the multiplexer to a second internal circuit of the LCD panel driver.

15. The LCD as claimed in claim 9, wherein the system controlling signals comprise a read signal, a write signal, a register select signal, and a chip select signal.

16. The LCD as claimed in claim 9, wherein the image controlling signals comprise a vertical synchronization signal, a horizontal synchronization signal, a dot clock signal, and a data enable signal.
